(19) United States
(12) Patent Application Publication
(10) Pub. No.: US 2020/0274927 A1
(43) Pub. Date: Aug. 27, 2020

(54) VEHICLE NETWORK TOPOLOGY SCHEME AND SYSTEMS FOR IMPLEMENTING THE SAME

(71) Applicant: Byton North America Corporation, Santa Clara, CA (US)

(72) Inventors: Trampus Richmond, Santa Cruz, CA (US); Michael Fairman, Rialto, CA (US)

(21) Appl. No.: 16/283,274

(22) Filed: Feb. 22, 2019

(51) Int. Cl. H04L 29/08; H04L 12/40

(52) U.S. Cl. CPC H04L 67/12; H04L 12/40; H04L 2012/40273; H04L 2012/40234; H04L 2012/40215

(57) ABSTRACT

Vehicle network topology schemes and systems are disclosed. For one example, a data processing system, e.g., a server or computer, includes an interface and a processor. The receiver can receive one or more CAN, LIN or Ethernet network descriptor files related to one or more ECUs interconnected within a network topology of a vehicle. The processor can convert the one or more CAN, LIN or Ethernet descriptor files into a uniform network descriptor file and auto-generate one or more ECU specific files or code using the uniform network descriptor file for use by the one or more ECUs such that messages, data or signals can be communicated between the ECUs in the network topology.

### FIELD

Embodiments of the invention are in the field of vehicles and communications including computer networking. More particularly, embodiments of the invention relate to a vehicle network topology scheme and systems for implementing the scheme.

### BACKGROUND

Vehicles such as electric or non-electric automobiles or sports utility vehicles (SUVs) can have any number of electronic control units (ECUs) to control functions or components of a vehicle such its motor, power steering, headlights, braking, etc. ECUs can be a micro-controller running firmware or code to perform its designated function and to send messages to other ECUs within the vehicle, e.g., the motor ECU communicating with the braking ECU. The network topology interconnecting the ECUs can be based on any number of different types of bus protocols and networks including the Controller Area Network (CAN), Local Interconnect Network (LIN), or Ethernet networks. Each of these different networks can use their own network descriptor file that describes the networks and the messages and formats for communicating between ECUs over their respective networks. Vehicles may have ECUs operating under different or mixed networks using different network descriptor files thus requiring extensive engineering effort and coordination to design ECUs for vehicles needing to communicate messages across different networks and bus protocols.

### SUMMARY

Vehicle network topology schemes and systems are disclosed. For one example, a network topology scheme for a vehicle uses a uniform network descriptor file that is agnostic to any network protocol, specific programming language or application software stack. In other words, the uniform network descriptor file need not follow specific formats required by a particular network or protocol, programming language or application software stack. The uniform network descriptor file can describe messages, signals and data used by electronic control units (ECUs) in a generic manner for communication across different networks and protocols. For example, the uniform network descriptor file can describe the overall network topology of the vehicle that may include ECUs on different or mixed networks including Controller Area Network (CAN), Local Interconnect Network (LIN), or Ethernet networks without being network specific.

For one example, the uniform network descriptor file includes a description of a plurality of nodes in the network topology of the vehicle, each description describes a node including one or more topics subscribed by the node, one or more services related to the one or more topics subscribed by the node, and one or more messages and signals related to each service of each topic. The description in the uniform network descriptor file can provide a generic way of describing how messages, signals and data can be communicated across all networks including mixed networks from ECU to ECU. The uniform network descriptor file can be a plain text file used to auto-generate ECU specific files and code such that ECUs can communicate with ECUs on different networks and protocols. The uniform network descriptor file can be easily updated if any changes or updates are made to the messages, signals or date used by ECUs in the network topology of the vehicle.

For one example, a data processing system includes an interface and a processor. The interface receives one or more network descriptor files related to one or more electronic control units (ECUs) interconnected within a network topology of the vehicle. The processor is coupled to the interface and configured to convert the one or more network descriptor files into a uniform network description file that is agnostic to any programming language or application software stack. The uniform network descriptor file describes the network topology of the vehicle without being specific to any network or protocol. The processor is further configured to auto-generate one or more ECU specific files or code using the uniform network description file for use by the one or more ECUs.

For one example, the interface can receive one or more updated network descriptor files and the processor can convert the one or more updated network description files into an updated uniform network description file and to auto-generate one or more updated ECU specific files or code using the updated uniform network descriptor file for the one or more ECUs. The processor can also distribute the ECU specific files or code or updated ECU specific files or code to one or more ECUs and the one or more ECUs to use the ECU specific files or code or updated ECU specific files or code.

For one example, the network topology of the vehicle includes Controller Area Network (CAN), Local Interconnect Network (LIN), or Ethernet networks. The one or more network descriptor files or updated network descriptor files includes a CAN network descriptor file or updated CAN network descriptor file, a LIN network descriptor file or updated LIN descriptor file, or an Ethernet network descriptor file or updated Ethernet network descriptor file. Such network descriptor files for these individual networks can be converted into a uniform network descriptor file or an updated uniform descriptor file that describes the network topology including the individual networks without being specific to any network.

For one example, the ECU specific files or updated ECU specific files can include routing tables or updated routing tables describing the network topology of the vehicle or ECU specific network descriptor files or updated ECU specific network descriptor files describing messages, data and signals used across the network topology of the vehicle. The ECU specific code or updated ECU specific code can include connectivity code or updated connectivity code used such that ECUs can communicate messages, data or signals across the network topology of the vehicle.

Other devices, apparatuses, computer-readable media and systems are described.

### BRIEF DESCRIPTION OF THE DRAWINGS

The appended drawings illustrate examples and are, therefore, exemplary embodiments and not considered to be limiting in scope.

FIG. 1A illustrates one example of a vehicle having a network topology scheme.

FIG. 1B illustrates one example of interconnected subsystem nodes according to a network topology scheme of FIG. 1A.

FIG. 2 illustrates one example of a networking environment interconnecting the vehicle gateway of FIG. 1A with a data processing system or server.

FIG. 3A illustrates one example of a flow diagram of a process to convert network descriptor files for electronic control units (ECUs) of a vehicle into a uniform network descriptor file.

FIG. 3B illustrates one example of a uniform network descriptor file of FIG. 3A.

FIG. 4A illustrates one example of a flow diagram of a process of auto-generating ECU specific files or code.

FIG. 4B illustrates one example of a flow diagram of a process of auto-generating updated ECU specific files or code.

FIG. 4C illustrates one example of ECU specific connectivity code and updated connectivity code.

FIG. 5 illustrates one example of a flow diagram of a process for a vehicle with ECUs running updated ECU specific connectivity code.

FIG. 6 illustrates one example of a flow diagram of a process for a vehicle gateway communicating messages with updated signals.

### DETAILED DESCRIPTION

Vehicle network topology schemes and systems are disclosed. For one example, a network topology scheme for a vehicle uses a uniform network descriptor file that is agnostic to any networking protocol, programming language or software stack, which does need not follow their rigid formatting rules. The uniform network descriptor file can describe messages, signals, data and nodes used by electronic control units (ECUs) in a generic manner in order to communicate with ECUs across different networks and protocols. For example, the uniform network descriptor file can describe the overall network topology of the vehicle regardless of the ECUs are on different or mixed networks such as a Controller Area Network (CAN), Local Interconnect Network (LIN), or Ethernet network.

For one example, a data processing system, e.g., a server or computer, can include an interface and a processor. The receiver can receive one or more CAN, LIN or Ethernet network descriptor files related to one or more ECUs interconnected within a network topology of a vehicle. The processor can convert the one or more CAN, LIN or Ethernet descriptor files into a uniform network descriptor file and auto-generate one or more ECU specific files or code using the uniform network descriptor file for use by the one or more ECUs in order to communicate messages, signals or data across the network topology. Such files or code can be stored in a memory or database for distribution to ECUs or other subsystem nodes within the vehicle.

As set forth herein, various embodiments, examples and aspects will be described with reference to details discussed below, and the accompanying drawings will illustrate various embodiments and examples. The following description and drawings are illustrative and are not to be construed as limiting. Numerous specific details are described to provide a thorough understanding of various embodiments and examples. However, in certain instances, well-known or conventional details are not described in order to provide a concise discussion of the disclosed embodiments and examples.

### Vehicle and Network Topology Scheme

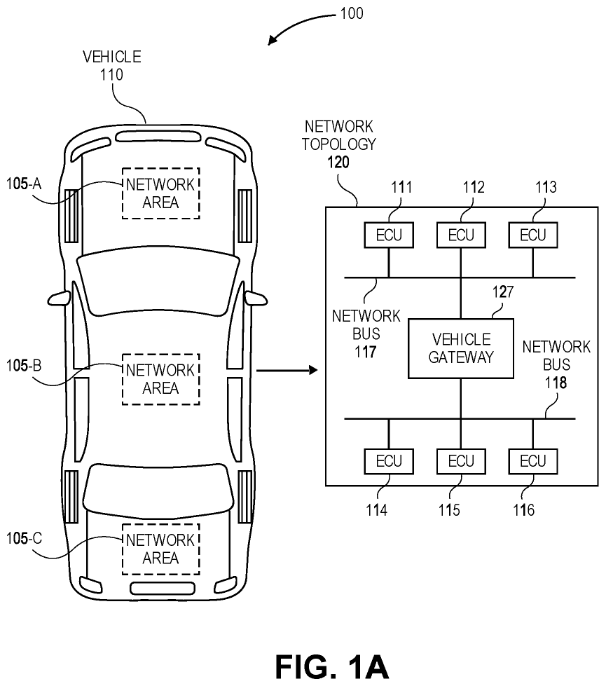

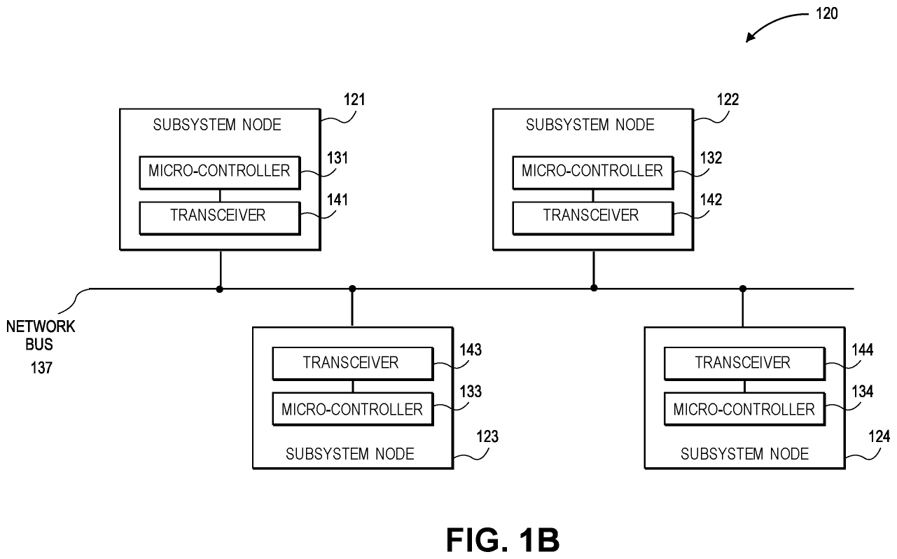

FIG. 1A illustrate one example of a top view 100 of a vehicle 110 having a network topology 120 including network areas 105-A through 105-C. Network topology 120 includes interconnected electronic control units (ECUs) 111-116 of for electronic subsystems of vehicle 110 by way of network busses 117 and 118, which can for subsystem nodes, e.g., subsystem nodes 121-124 as shown in FIG. 1B. For one example, each ECU 111-116 can include a micro-controller, system-on-chip (SOS), or any embedded system that can run firmware or program code stored in one or more memory devices or hard-wired to perform operations or functions for controlling components, functions or services within vehicle 110. Although FIG. 1A shows three network areas 105-A, 105-B and 105-C, any number of network areas can be located throughout vehicle 110. Each network area can include any number ECUs interconnected by way of network topology 120.

For one example, each ECU 111-116 can run firmware or code or be hard-wired to perform its function and control any number of electronic components, functions or services operating within vehicle 110. For example, ECUs in the front end such as network area 150-A can have ECUs controlling electronic components or functions for headlights, power steering, parking, braking, display and engine controls etc. Network area 150-B in the mid-section of vehicle 110 can have ECUs controlling electronic components or functions for opening and closing door locks and other interior controls and the main high voltage power supply 103. Network area 150-C near the back end of vehicle 110 can have ECUs controlling electronic components for tail lights, battery, power control etc. The ECUs in the different networking areas of vehicle 110 can communicate messages, signals or data with each other by way of network topology 120 on network busses 117 and 118. Although two network busses 117 and 118 are shown in FIG. 1A, any number of network busses may be used to interconnect ECUs 111-116 within network topology 120.

For one example, network topology 120 includes a vehicle gateway 127 interconnecting ECUs 111-113 on network bus 117 with ECUs 114-116 on network bus 118. Network busses 117 and 118 can provide messages, signals and data using different network protocols—i.e., mixed network protocols. For one example, vehicle gateway 127 can include a micro-controller, central processing unit (CPU), or processor or be a computer and data processing system to coordinate communication on network topology 120 between the ECUs 111-116 on any number of networks and protocols. Vehicle gateway 127 can also have a network interface, e.g., a wired or wireless interface, to connect externally to a network including the Internet or cloud environment and communicate messages, signals and, e.g., global positioning system (GPS) signals and data or uniform network descriptor files.

For one example, network topology 120 can include different types or mixed networks including Controller Area Network (CAN), Local Interconnect Protocol (LIN), and Ethernet networks and busses 117 and 118 can support communication according to CAN, LIN or Ethernet protocols. For example, network area 105-A can include a CAN network of ECUs, network area 105-B can include a LIN network and network area 105-C can include an Ethernet network. For another example, ECUs 111-113 can communicate messages, signals and data on network bus 117 according to a LIN protocol and ECUs 114-116 can communicate messages, signals and data on network bus 118 according to a CAN protocol. For other examples, ECUs 111-116 can communicate on network busses 117 and 118 using the same protocol, e.g., CAN protocol. Any combination or mixed networks and protocols can be implemented within network topology 120 of vehicle 110 in which ECUs 111-116 on of mixed networks can communicate with each other.

For one example, ECUs interconnected using a CAN network can be described using a CAN network descriptor file such as a CAN database container (DBC) file. A CAN DBC file contains a database format structure unique to CAN specific messages and signals. It can also describe the network topology used on the CAN network. Similarly, ECUs interconnected using LIN network can be described using a LIN descriptor file (LDF) unique to LIN specific messages and signals that describes the network topology used on the LIN network. ECUs interconnected using the Ethernet network can be described using Ethernet network descriptor file unique to Ethernet specific messages and signals and network components. These ECU specific network descriptor files can describe network topology 120 and the interconnected ECUs within their respective networks.

For some examples, ECUs within network topology 120 can have its own specific network descriptor file, which are different from network descriptor files used by other ECUs. For example, ECUs for network area 105-A can be on a CAN network using a CAN DBC file, ECUs for network area 105-B can be a LIN network using a LDF file, and network area 105-C can be an Ethernet network using an Ethernet file. Each ECU can run firmware or code based on messages, signals and data defined by their respective network descriptor files unique to their respective protocol and ECU. Alternatively, network areas 105-A through 105-C can all be on the same type of network with each ECU having its own network descriptor file.

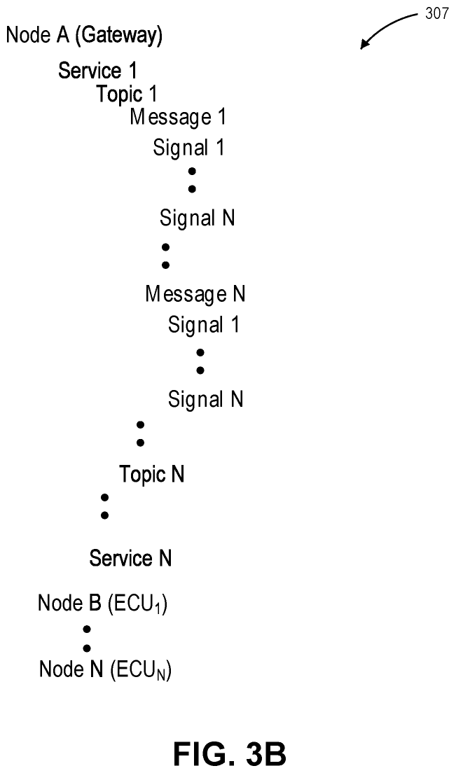

For one example, the network descriptor files for each of the ECUs 111-116, which can be based on different networks and protocols, are converted into a uniform network descriptor file as described in FIG. 3B. The uniform network descriptor file can be a generic text file providing a single source and hierarchical view of interconnected ECUs 111-116 regardless of network type and protocol used within network topology 120 of vehicle 110. The uniform network descriptor file can describe messages, signals and data in a generic manner across different networks and protocols, e.g., CAN, LIN or Ethernet networks. ECU specific files and code can be auto-generated using the uniform network descriptor file to communicate with ECUs throughout network topology 120 regardless of type of networks or protocols used.

FIG. 1B illustrates one exemplary block diagram of network topology 120 of FIG. 1A having a plurality of interconnected subsystem nodes 121-124 on network bus 137. The subsystem nodes 121-124 can represent ECUs 111-116 or vehicle gateway 127 in FIG. 1A. Although four subsystem nodes are shown, any number of subsystem nodes can be implemented for network topology 120 of vehicle 110. Each of the subsystem nodes 121-124 includes respective transceivers 141-144 and micro-controllers 131-134. Each of the subsystem nodes 121-124 are coupled to network bus 137, which can support any type of vehicle network, e.g., a CAN, LIN or Ethernet network. For example, transceivers 141-144 can support data messaging according to the ISO 11898-1, ISO/AWI 17987-8 and IEEE 802.11 protocols. Micro-controllers 131-134 can control vehicle components, functions or services and communicate with other subsystem nodes. For other examples, network bus 137 is coupled to a vehicle gateway 127 and subsystem nodes 121-124 are coupled to vehicle gateway 127 or, alternatively, a subsystem node can be a vehicle gateway 127. The micro-controllers 131-134 can run firmware or code according to respective network descriptor files to communicate messages, signals and data to other subsystem nodes.

For one example, if an ECU or subsystem node 121-124 needs to communicate with other ECUs or subsystem nodes on a different network or protocol, ECU specific files or code can be auto-generated using the uniform network descriptor file for the ECU or subsystem nodes. For one example, a routing table file can be auto-generated such that ECUs and subsystem nodes regardless of network or protocol to identify subsystem nodes in the network topology 120. For another example, ECU specific network descriptor file can be auto-generated using the uniform network descriptor file that includes messages, signals and data for other types of networks. For another example, ECU connectivity code can be auto-generated that generates code for an ECU to communicate messages, signals or data to other ECUs on other networks or protocols. If an update is made to any of the network descriptor files, the uniform network descriptor file can be updated and distributed to all the ECUs and subsystem nodes.

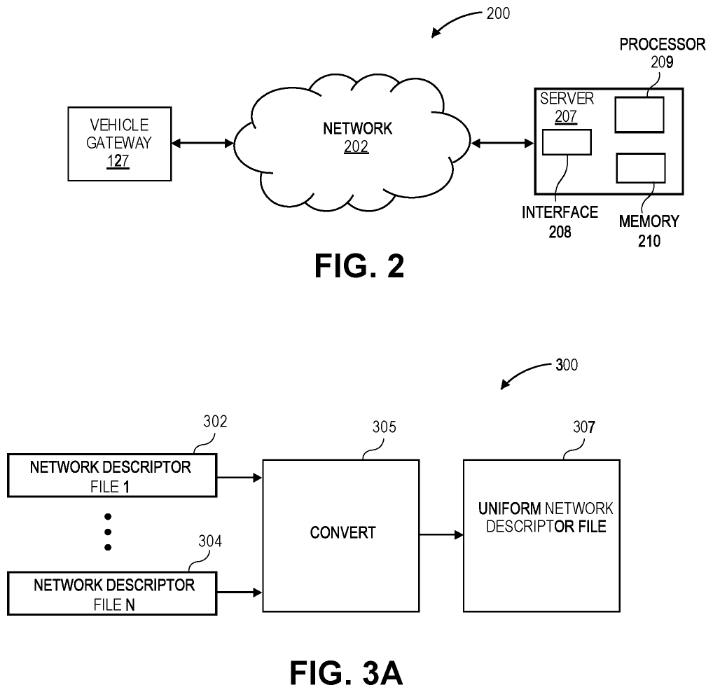

FIG. 2 illustrates one example of a networking environment 200 interconnecting the vehicle gateway 127 of FIG. 1A with a data processing system, computer or server 207 via a network 202. Network 202 can be a wired or wireless network including a cloud environment, Internet or other types of interconnected networks. Vehicle gateway 127 can include an interface to couple with and communicate messages, signals and data on network 202 to and from server 207. For one example, server 207 can be any type of data processing system or computer to implement the techniques, operations, methods and processes as described herein, e.g., embodiments and examples disclosed in FIGS. 3A-6. For other examples, vehicle gateway 127 can perform the same operations, methods and processes as server 207.

For one example, server 207 includes an interface 208 coupled with network 202, a memory to store network descriptor files and other data, and processor 209. Processor 209 is coupled to the interface 208 and memory 210. Processor 209 can include one or more central processing units (CPUs), a specialized processor or any combination thereof. Processor 209 can retrieve instructions from any of the memories including memory 210, which can also include a database, and execute instructions to perform operations as described herein. For one example, interface 208 can include a modem, wired or wireless transceivers and communicate messages, signals and data using any type o networking protocol including wired or wireless wide area network (WAN) and local area network (LAN) protocols including LTE® and Bluetooth® standards. Memory 210 can be any type of memory including random access memory (RAM), dynamic random-access memory (DRAM), or a database.

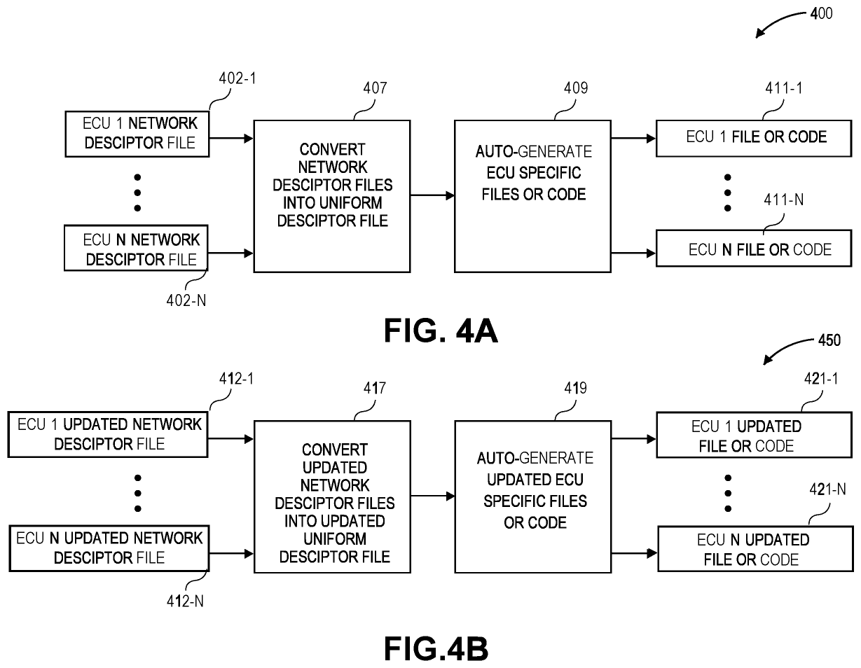

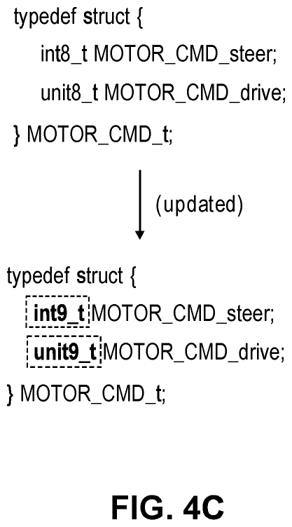

For one example, server 207 can generate a uniform network descriptor file 307, as described in FIGS. 3A-3B, using network descriptor files 1 to N for ECUs 111-116. The uniform network descriptor file 307 can provide a hierarchical or topological view of network topology 120 of interconnected ECUs 111-116 and vehicle gateway 127 within vehicle 110 regarding of individual within network topology 120. Server 207 can generate ECU specific files and code, e.g., as described in FIG. 4A-4C, using the uniform network descriptor file 307. For one example, the ECU specific files can include routing tables converted or generated from the uniform network descriptor file 307. The server 201 can also generate ECU specific network description files from the uniform network descriptor file 307 that can refer to messages, signals or data on different types of networks in which the specific ECU subscribes and to communicate with those ECUs. ECU specific code can include connectivity code, e.g., as shown in FIG. 4C, such that ECUs can communicate messages, data or signals across the network topology 120 of the vehicle 110. Alternatively, vehicle gateway 127 can perform the same auto-generation operation of ECU specific files or code as server 207.

For one example, sever 207 can distribute ECU specific files and code to ECUs 111-116 by way of vehicle gateway 127. For one example, server 207 can maintain and update the uniform network descriptor file 307 based on updates to ECUs 111-116 and related ECU network descriptor files. Server 207 can also generate updated ECU specific file and code, e.g., connectivity code, and distribute the updated files and code to ECUs 111-116 by way of gateway 127. In this way, a centralized and uniform manner of generating and distributing ECU specific files and code or updated ECU specific files or code can be achieved for a network topology scheme of mixed networks within vehicle 110.

For one example, ECUs 111-116 and related network descriptor files can be updated, which causes an update to the uniform network descriptor file 307 accordingly. The updated uniform network descriptor file 307 can be used to generate updated ECU specific files or code and distributed to ECUs 111-116. The uniform network descriptor file 307 can be maintained and stored by a server, e.g., server 207, or, alternatively by vehicle gateway 127, which can auto-generate ECU specific files or code or updated ECU specific files or code and distribute them to ECUs 151-156. For one example, gateway 157 can receive ECU specific files or code or updated ones from server 206 via network 202 and distribute them to ECUs 151-156. For one example, vehicle gateway 127 distributes ECU specific files or code (or updated ones) to those ECUs which have subscribed to messages, signals or data that has been updated. ECUs 111-116 can receive the ECU specific files or code or updated ECU specific files or code and run them for their respective functions, operations or services. In this way, distributing ECU specific files or code and updated ones to interconnected ECUs 111-116 within network topology 120 can be efficient and centralized with minimal effort within vehicle 110.

### Uniform Network Description File

FIG. 3A illustrates one example of a flow diagram of a process 300 to convert network descriptor files for a plurality of ECUs operating within vehicle 110 into a uniform network descriptor file as shown in FIG. 3B and in the Appendix. For one example, process 300 can be performed by server 207 or, alternatively, by vehicle gateway 127 of FIG. 2.

Referring to FIG. 3A, blocks 302 to 304 represent a plurality of network description files 1 to N. Each network description file 1 to N can be specific to a respective ECU. For example, network description files 1 to N can be defined for different networks or a mixed network, which can include CAN, LIN or Ethernet networks operating within vehicle 110. For other examples, network description files can be defined for the same network and protocol. At block 305, the network description files 1 to N are converted into a uniform network description file 307. For example, server 207 or, alternatively, vehicle gateway 127 can receive network descriptor files 1 to N and convert the files into a uniform network description file as structured in FIG. 3B having exemplary description as shown in the Appendix. Server 207 or vehicle 127 can input the network files 1 to N into a translator that can translate and convert details of nodes, messages, signals and data into a generic structure agnostic to any programming language or application software stack. The translator can be a software, firmware or code that is run on server 207 or vehicle gateway 127 that takes network description files 1 to N (302, 304) as inputs and converts their details and definitions which may specific to a particular network and protocol a generic high-level file a hierarchical format as shown in FIG. 3B that is not specific to any network or protocol or required to follow any specific format for any programming language, application software stack or network protocol.

FIG. 3B illustrates one example of a uniform network description file 307 and its format. The format describes a plurality of nodes A through N where node A can refer to a “Gateway” and node B can refer to ECU₁ and node N can refer to ECU_{N}. For example, referring to the Appendix, a sample uniform network description file is provided for a gateway node, e.g., “Node CGW.” A plurality of services can be related to each node. For example, referring to the sample uniform network description file in the Appendix, Node CGW has a service referred to as “Vehicle.” For each service, there are a plurality of topics that the node can subscribe to such that the node can receive updates, changes, or connectivity code for any messages, signals or data within that topic regardless of the network or protocol of the source of the messages, signals or data which can be on a different type of network. For example, service “Vehicle” includes topics “dynamics”, “doors” all the way to “preferences.”

For one example, within each topic, there are a plurality of messages and related signals and data for the topic. For example, referring to topic “warnings”, there is a Boolean message “tirePressureLow” signal. Each topic can describe the messages, signals and data used for that topic. Each node A through N can have the same format describing services, topics, messages and related signals and for that node.

Referring to FIGS. 1A-1B, 3B and the Appendix, the uniform network description file 307 can describe network topology 120 as a single source of information for connectivity to messages and related signals and data for ECUs 111-116 and subsystem nodes 121-124 within vehicle 110. For one example, uniform network description file 307 is generic and agnostic to any particular programming language or software protocol stack. For example, uniform network description file 307 does not require extensible markup language (XML) formatting, but can rely on natural language text of identifying nodes, services, topics, message and signal names on each line of the uniform network description file unlike a CAN DBF file, LIN LDF file or an Ethernet file that requires specific formatting rules designed for the networking protocol.

### Auto-Generating ECU Specific Files or Code Using Uniform Network Description File

FIG. 4A illustrates one example of a flow diagram of a process 400 of auto-generating ECU files or code. At block 407, ECU 1 network description file (401-1) through ECU N network description file (401-N) are converted into a uniform network descriptor file as described, e.g., in FIG. 3B and in the Appendix. For example, referring to FIG. 2, server 207 or vehicle gateway 127 can run a translator to cover the ECU 1 to N network descriptor files into a uniform network descriptor file (e.g., uniform network descriptor file 307) providing a generic file agnostic to any programming language and application software stack describing the messages, signals and data for the ECUs within network topology 120. At block 409, a file or code generator can generate ECU specific files and connectivity code using the uniform network descriptor file, e.g., uniform network descriptor file 307. For one example, ECU specific file can include a routing table identifying all the nodes in network topology 120 and related messages, signals and data traversing network topology 120. For another example, referring to FIG. 4C, the uniform network descriptor file 307 can describe a Node B for ECU₁ having a topic “Motor” with services for “Steer” and “Drive” with signals for “int8_t” and “unit8_t.” A description of the uniform network descriptor file for this node can be:

(Uniform Network Description File Example)
NODE B (ECU₁)

Topic Motor

Service Steer;

Message MOTOR_CMD_Steer;
Signal int8_t;

Service Drive;

Message MOTOR_CMD_Drive;
Signal unit8_t;

For one example, at block 409, a code generator in server 207 or vehicle gateway 127 can process the uniform network descriptor file and auto-generate ECU specific connectivity code:

(ECU Specific Connectivity Code Example)
typedef struct {

int8_int MOTOR_CMD_steer;
unit8_t MOTOR_CMD_drive;

} MOTOR_CMD_t;

Referring to FIG. 4A, for each ECU that subscribes to the topic “Motor,” at blocks 411-1 to 411-N, the code generator can auto-generate the above connectivity code for each ECU, e.g., ECU 1 to ECU N that subscribes to the topic “Motor.” The ECUs can use this connectivity code to implement respective services. For example, an ECU for braking may need to subscribe to the topic “Motor” and related messages and signals to implement braking services.

FIG. 4B illustrates one example of a flow diagram of a process 450 of auto-generating updated ECU files or code. At block 417, updated DBC files for ECU 1 (412-1) through ECU N (412-N) are input into a translator. Translator 417 translates the updated DBC files into an updated centralized connectivity description into a hierarchical format describing the updated connectivity within a network topology of a vehicle (e.g., network topology 150). At block 419, a code generator generates updated connectivity code from the updated centralized connectivity description. For example, referring to FIG. 4C, the centralized connectivity description 307 can describe a Node for an ECU controlling a “Motor” having services for “Steer” and “Drive” with updated signals for “int9_t” and “unit9_t”—which updated former signals “int8_t” and “unit8_t.” The centralized network connectivity description for this node can be:

(Updated Uniform Network Descriptor File Example)
NODE B (ECU₁)

Topic Motor

Service Steer;

Message MOTOR_CMD_Steer;
Signal int9_t;

Service Drive;

Message MOTOR_CMD_Drive;
Signal unit9_t;

For the above updated uniform network descriptor file, at block 419, a code generator in server 207 or vehicle gateway 127 can process the updated network descriptor file to auto-generate updated ECU specific connectivity code as:

(Updated Connectivity Code Example)
typedef struct {

int9_int MOTOR_CMD_steer;
unit9_t MOTOR_CMD_drive;

} MOTOR_CMD_t;

Referring to FIG. 4B, for each ECU that subscribes to the topic “Motor,” at blocks 421-1 to 421-N, the code generator can auto-generate the above updated connectivity code for each ECU, e.g., ECU 1 to ECU N that subscribes to the topic “Motor.” The ECUs can use this updated connectivity code to implement updated respective services.

### Vehicle and Gateway Operation Examples

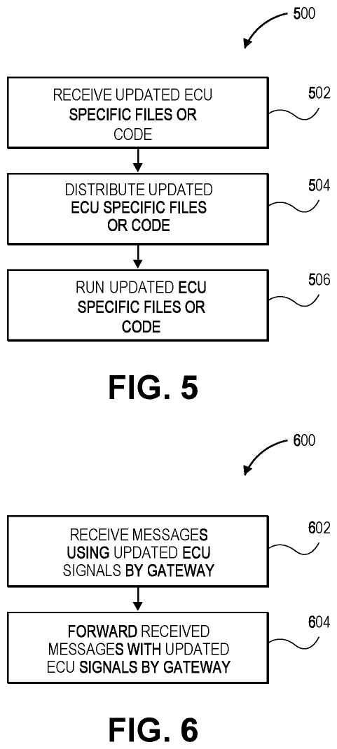

FIG. 5 illustrates one example of a flow diagram of a process 500 for a vehicle (e.g., vehicle 110) with ECUs (e.g., ECUs 111-116) running updated ECU specific files or code (e.g., as described in FIGS. 4A-4C). At block 502, updated ECU specific files or code is received. For example, vehicle gateway 127 can receive updated ECU specific files or code server 207.

At block 504, the updated ECU specific files or code are distributed to ECUs 111-116. For example, vehicle gateway 127 can distribute updated ECU specific files (e.g., updated routing tables or ECU specific network descriptor files auto-generated by an updated uniform network descriptor file) or code (e.g., connectivity code as shown in FIG. 4C).

At block 506, ECUs run the distributed updated connectivity code. For one example, a group of ECUs can receive the distributed updated ECU specific files or a single ECU can receive the updated ECU specific files or code and run them.

FIG. 6 illustrates one example of a flow diagram of a process 600 for a vehicle gateway (e.g., vehicle gateway 127). At block 602, vehicle gateway 127 can receive messages with updated signals from one or more ECUs (e.g., ECUs 111-116).

At block 604, vehicle gateway 127 can forward messages with updated signals from a group of ECUs (e.g., ECUs 111-113) to another group of ECUs (e.g., ECUs 114-116) connected on busses 117 and 118. Each group of ECUs can be on different networks using different bus protocols. In other examples, vehicle gateway 127 can send messages to the network 202 and to one or more servers, e.g., server 207.

### APPENDIX

The following shows an exemplary uniform network descriptor file providing a description for a gateway node. This exemplary uniform network descriptor file may be subject to Copyright protection.

# Pre-AP Gateway
<“updater.vnt”
<“bladebox.vnt”
<“logger.vnt”
<“diag.vnt”
<“tba.vnt”
<“ice.vnt”
<“ecu.vnt”
Node CGW {

```
  ip “tcp://192.168.111.2”
  import CGWUpdater
  import TBA
  import ICET
  import ICE
  Service vehicle {
```

Topic dynamics {period = 100

```
  int gear //
  CAN_Chassis[1,2].CDI_PwrtrainDriveStatus.powerTrainActualGearStatus_CDI
  float speed ( in: CAN_Chassis2.ESP_iBoostData1.vehSpeed_ESP, fn:
  metersSecToKPH )
  float odometer ( in:
  CAN_Chassis2.CDI_OdometerInfo.powerTrainHMIOdometerInfo_CDI )
  bool leftTurn ( in: CAN_Body1.FBCM_VehInfo1.turnIndicatorLt_FBCM )
  bool rightTurn ( in: CAN_Body1.FBCM_VehInfo1.turnIndicatorRt_FBCM )
  bool hazard ( in: CAN_Body1.FBCM_VehInfo1.hazardModeStatus_FBCM )
  bool ready //
  CAN_Chassis1.CDI_PwrtrainDriveStatus.powerTrainDriveReadiness_CDI ==
  Drive_Ready
```

}
Topic doors { period = 100

```
  bool windowClosed_P
  bool windowClosed_D
  bool windowClosed_RR
  bool windowClosed_RL
  bool trunkAjar ( in: CAN_Body1.RBCM_VehInfo1.trunkAjar_RBCM )
  bool hoodAjar ( in: CAN_Body1.FBCM_VehInfo1.hoodAjar_FBCM )
  bool doorAjarP ( in: CAN_Body1.FBCM_VehInfo1.doorAjarP_FBCM )
  bool doorAjarD ( in: CAN_Body1.FBCM_VehInfo1.doorAjarD_FBCM )
  bool doorAjarRR ( in: CAN_Body1.RBCM_VehInfo1.doorAjarRR_RBCM )
  bool doorAjarRL ( in: CAN_Body1.RBCM_VehInfo1.doorAjarRL_RBCM )
  int doorLockP ( in: CAN_Body1.FBCM_VehInfo1.doorLockP_FBCM )
  int doorLockD ( in: CAN_Body1.FBCM_VehInfo1.doorLockD_FBCM )
  int doorLockRR ( in: CAN_Body1.RBCM_VehInfo1.doorLockRR_RBCM )
  int doorLockRL ( in: CAN_Body1.RBCM_VehInfo1.doorLockRL_RBCM )
  // these are redundant with the above, used by ICE code temporarily
  bool frontLeft ( in: CAN_Body1.FBCM_VehInfo1.doorAjarD_FBCM )
  bool frontRight ( in: CAN_Body1.FBCM_VehInfo1.doorAjarP_FBCM )
  bool rearLeft ( in: CAN_Body1.RBCM_VehInfo1.doorAjarRL_RBCM )
  bool rearRight ( in: CAN_Body1.RBCM_VehInfo1.doorAjarRR_RBCM )
  bool frunk ( in: CAN_Body1.FBCM_VehInfo1.hoodAjar_FBCM )
  bool trunk ( in: CAN_Body1.RBCM_VehInfo1.trunkAjar_RBCM )
```

```
  }
  Topic tireStatus2 { period = 100
```

```
  float tirePressFL_TPMS ( in:
  CAN_Body1.TPMS_TirePressureStatus2.tirePressFL_TPMS )
  float tirePressFR_TPMS ( in:
  CAN_Body1.TPMS_TirePressureStatus2.tirePressFR_TPMS )
  float tirePressRL_TPMS ( in:
  CAN_Body1.TPMS_TirePressureStatus2.tirePressRL_TPMS )
  float tirePressRR_TPMS ( in:
  CAN_Body1.TPMS_TirePressureStatus2.tirePressRR_TPMS )
  int tireTempFL_TPMS ( in:
  CAN_Body1.TPMS_TirePressureStatus2.tireTempFL_TPMS )
  int tireTempFR_TPMS ( in:
  CAN_Body1.TPMS_TirePressureStatus2.tireTempFR_TPMS )
  int tireTempRL_TPMS ( in:
  CAN_Body1.TPMS_TirePressureStatus2.tireTempRL_TPMS )
  int tireTempRR_TPMS ( in:
  CAN_Body1.TPMS_TirePressureStatus2.tireTempRR_TPMS )
```

}
Topic warnings { period = 100

```
  bool tirePressureLow
  bool brakeFail // ESP_BrakeSystemStatus1.brakeSysFail_ESP |
  iBoost_BrakeBoosterStatus1.brakeSysWarn_iBoost
  bool transmissionFail
  bool steeringWheelFail // primSysFault_EPAS1 | secSysFault_EPAS2
  bool airbagDeployed ( in:
  CAN_Chassis2.ACM_AirbagInfo4.crashAirbagStatus_ACM )
  bool frontWasherFluidLow
  bool rearWasherFluidLow
  bool extBulbFail
  bool airbagFail ( in: CAN_Chassis2.ACM_AirbagInfo2.requestRILStatus_ACM,
  no: PREAP )
  bool temperatureWaming
```

}
Topic drivewarnings { period = 100

```
  bool abs // ESP_BrakeSystemStatus1.statusABS_ESP |
  ESP_iBoostData3.actvABS_ESP
  bool stabilityControl ( in:
  CAN_Chassis1.ESP_BrakeSystemStatus1.statusDSC_ESP, no: PREAP )
  bool limpMode ( in:
  CAN_Chassis2.CDI_PwrtrainHMIsignals.powerTrainHMILimpHome_CDI )
  int parkBrake ( in:
  CAN_Chassis1.ESP_BrakeSystemStatus1.parkBrakeStatus_ESP, no: PREAP )
```

```
  }
  Topic battery { period = 100
```

bool isCharging ( in:
CAN_Chassis2.CDI_HVsystemActiveStatus.highVoltageActPlugInCharging_CDI

)

```
  int driveRangeToEmpty ( in:
  CAN_Chassis2.CDI_PwrtrainHVbattStatus1.powerTrainHMIAvaDrvRange_CDI
```

)
int chargeTimeToFull
float charge ( in:
CAN_Chassis2.CDI_PwrtrainHVbattStatus1.powerTrainHMIHVBatSoc_CDI )
int percentageCharged ( in:
CAN_Chassis2.CDI_PwrtrainHVbattStatus1.powerTrainHMIHVBatSoc_CDI )
bool temperatureHigh ( in:

CAN_Chassis2.CDI_PwrtrainHMIsignals.powTrainHMIHVBatCoolOvrTemp_CDI

)
bool malfunction
int condition
int fluid
bool shutoff
bool extemalCableConnected //
CAN_Chassis2.CDI_PlugInChrgInfo1.chrgSystemStatus_CDI

}
Topic systemfailure { period = 100

```
  bool batteryfailure ( in:
  CAN_Chassis2.CDI_PwrtrainHMIsignals.powerTrainHMIHVBatCriFail_CDI )
  bool electricMotorFail // powerTrainHMIDriveMotOvrTemp_CDI |
  powerTrainHMIDriveMotOverSpd_CDI
  bool motorTemperatureHigh ( in:
CAN_Chassis2.CDI_PwrtrainHMIsignals.powerTrainHMIDriveMotOvrTemp_CDI
  )
  bool systemCriticalFailure ( in:
  CAN_Chassis2.CDI_PwrtrainHMIsignals.powerTrainHMICriSysFailure_CDI )
```

}
Topic battery12v { period = 100

```
  int percentageCharged ( in:
  CAN_Chassis2.CDI_IBSstatus2.bat12vStateOfChargeIBSInfo_CDI )
```

}
Topic drivinglights { period = 100

```
  bool autoBeam
  bool parking
  bool lowBeam ( in: CAN_Body1.FBCM_VehInfo1.lowBeamOn_FBCM )
  bool highBeam ( in: CAN_Body1.FBCM_VehInfo1.highBeamOn_FBCM )
  bool fogFront
  bool fogRear ( in: CAN_Body1.RBCM_VehInfo1.fogLampsOnRR_RBCM )
  bool externalBulbFail
  bool daytimeLights
```

```
  }
  Topic wipers { period = 100
```

```
  bool frontAuto
  bool mist
  bool low // wiperStatusFt_FBCM == Low_Speed
  bool adjustable
  int speed
  bool high // wiperStatusFt_FBCM == High_speed
  bool rear
```

```
  }
  Topic seatbelts { period = 100
```

bool driver ( in:
CAN_Chassis2.ACM_AirbagInfo1.drivSeatBeltBcklState_ACM, fn: invert )
bool passengerFront ( in:
CAN_Chassis2.ACM_AirbagInfo1.passSeatBeltBcklState_ACM, fn: invert )
bool passengerRearLeft
bool passengerRearRight

```
  }
  Topic airbags { period = 100
```

bool driver
bool passengerFront

}
Topic adas { period = 100

```
  bool laneAssist
  bool adaptiveCruiseControl
  float speedLimit
  int setSpeed
  int laneDetectedLeft
  int laneDetectedRight
  int laneMarkingDetectedLeft
  int laneMarkingDetectedRight
  int carDetectedLeft
  int carDetectedRight
  int carDetectedFrontRight
  int carDetectedFrontLeft
  int carDetectedFront
```

}
Topic fluids { period = 100

```
  int frontWasherFluidLevel
  int rearWasherFluidLevel
```

}
Topic preferences { period =100

```
  int region
  int distanceUnits
```

}

```
  }
  Service tablet {
```

Topic status { period = 100

```
  HvacCtrls hvac
  BodyCtrls body
```

}

}
Service status {

Topic power {

period = 1000
int wakeSleepFIC
int vehiclePowerMode
int vehicleTimeout

}

Topic heartbeat { period = 100

time systemTime

// TBD: ECU states
}

```
  }
  Routing {
```

Body1: bodycan
Chassis1: chas1can
Chassis2: chas2can
eDrive: edrivecan
Thermal: thermalcan
ICE: icecan

}

}

In the foregoing specification, the invention has been described with reference to specific exemplary embodiments thereof. It will, however, be evident that various modifications and changes may be made thereto without departing from the broader spirit and scope of disclosed examples and embodiments. The specification and drawings are, accordingly, to be regarded in an illustrative rather than a restrictive sense.

1. A data processing system comprising:
an interface to receive one or more network descriptor files related to one or more electronic control units (ECUs) interconnected within a network topology of the vehicle; and
a processor coupled to the interface and configured to
convert the one or more network description files into a uniform network descriptor file that is agnostic to any programming language or application software stack, the uniform network description file describes the network topology of the vehicle without being specific to any network or protocol related to the ECUs, and
auto-generate one or more ECU specific files or code using the uniform network descriptor file for use by the one or more ECUs.

2. The data processing system of claim 1, wherein the interface is to receive one or more updated network descriptor files and the processor configured to convert the one or more updated network descriptor files into an updated uniform network descriptor file and to auto-generate one or more updated ECU specific files or code using the updated uniform network descriptor file for use by the one or more ECUs.

3. The data processing system of claim 2, wherein the processor is configured to distribute the ECU specific files or code or updated ECU specific files or code to one or more ECUs and the one or more ECUs to use the ECU specific files or code or updated ECU specific files or code.

4. The data processing system of claim 2, wherein the ECU specific files or updated ECU specific files include routing tables or updated routing tables describing the network topology of the vehicle or ECU specific network descriptor files or updated ECU specific network descriptor files describing messages, data and signals used across the network topology of the vehicle.

5. The data processing system of claim 2, wherein the ECU specific code or updated ECU specific code includes connectivity code or updated connectivity code used to communicate messages, data or signals between ECUs in the network topology of the vehicle.

6. The data processing system of claim 2, wherein the network topology of the vehicle includes Controller Area Network (CAN), Local Interconnect Network (LIN), or Ethernet networks,
wherein the one or more network descriptor files or updated network descriptor files includes a CAN network descriptor file or updated CAN network descriptor file, a LIN network descriptor file or updated LIN descriptor file, or an Ethernet network descriptor file or updated Ethernet network descriptor file.

7. The data processing system of claim 1, wherein the uniform network descriptor files includes a description of a plurality of nodes in the network topology of the vehicle, each description describes a node including one or more topics subscribed by the node, one or more services related to the one or more topics subscribed by the node, and one or more messages and signals related to each service of each topic.

8. A method for a vehicle
receiving one or more network descriptor files related to one or more electronic control units (ECUs) interconnected within a network topology of the vehicle;
converting the one or more network description files into a uniform network descriptor file that is agnostic to any programming language or application software stack, the uniform network descriptor file describes the network topology of the vehicle without being specific to any network or protocol related to the ECUs; and
auto-generating one or more ECU specific files or code using the uniform network descriptor file for use by the one or more ECUs.

9. The method of claim 8, wherein the method further comprises:
receiving one or more updated network descriptor files;
converting the one or more updated network descriptor files into an updated uniform network descriptor file; and
auto-generating one or more updated ECU specific files or code using the updated uniform network descriptor file for the one or more ECUs.

10. The method of claim 9, further comprising:
distributing the ECU specific files or code or updated ECU specific files or code to one or more ECUs; and
using the ECU specific files or code or updated ECU specific files or code by the one or more ECUs.

11. The method of claim 10, wherein the ECU specific files or updated ECU specific files include routing tables or updated routing tables describing the network topology of the vehicle or ECU specific network descriptor files or updated ECU specific network descriptor files describing messages, data and signals used across the network topology of the vehicle.

12. The method of claim 9, wherein ECU specific code or updated ECU specific code includes connectivity code or updated connectivity code used to communicate messages, data or signals across the network topology of the vehicle.

13. The method claim 12, further comprising:
communicating messages, data or signal between the ECUs in the network topology of the vehicle using the connectivity code or updated connectivity code.

14. The method of claim 9, wherein the network topology of the vehicle includes Controller Area Network (CAN), Local Interconnect Network (LIN), or Ethernet networks, and wherein the one or more network descriptor files or updated network descriptor files includes a CAN network descriptor file or updated CAN network descriptor file, a LIN network descriptor file or updated LIN descriptor file, or an Ethernet network descriptor file or updated Ethernet network descriptor file.

15. The method of claim 8, wherein the uniform network descriptor files includes a description of a plurality of nodes in the network topology of the vehicle, each description describes a node including one or more topics subscribed by the node, one or more services related to the one or more topics subscribed by the node, and one or more messages and signals related to each service of each topic.

16. A vehicle comprising:
a plurality of electronic control units (ECUs) interconnected according to a network topology; and
a gateway coupled to the ECUs, the gateway to distribute one or more ECU specific files or code derived from a uniform network descriptor file that is agnostic to any programming language or application software stack and describes the network topology of the vehicle without being specific to any network or protocol.

17. The vehicle of claim 16, wherein the network topology of the vehicle includes a Controller Area Network (CAN), Local Interconnect Network (LIN), or an Ethernet network.

18. The vehicle of claim 16, wherein the gateway distributes updated ECU specific files or code to one or more ECUs.

19. The vehicle of claim 18, wherein the gateway distributes messages between ECUs based on the updated ECU specific files or code.

20. The vehicle of claim 19, wherein the ECU specific code or updated ECU specific code includes connectivity code or updated connectivity code used to communicate messages, data or signals between ECUs in the network topology of the vehicle.
